(19) United States
(12) Patent Application Publication
(10) Pub. No.: US 2026/0002389 A1
(43) Pub. Date: Jan. 1, 2026

(54) VEHICLE DOOR LOCK APPARATUS

(71) Applicant: ANSEI CORPORATION, Obu-City (JP)

(72) Inventors: Satoshi YAMAJI, Obu-City (JP); Kunihiko OKADA, Obu-City (JP)

(21) Appl. No.: 19/050,185

(22) Filed: Feb. 11, 2025

(30) Foreign Application Priority Data
Jun. 27, 2024 (JP) 2024-104092

(51) Int. Cl. E05B 81/16; E05B 81/90

(52) U.S. Cl. CPC E05B 81/16; E05B 81/90

(57) ABSTRACT

In a vehicle door lock apparatus (1), a housing (7, 9) includes a manipulation hole (92), which passes through a first wall (91) forming a side surface (97D) of an entry groove (97) and through which a manipulation member (J1), which is separate from the vehicle door lock apparatus, is insertable. A lock lever (40) includes: a second wall (42) having an opposing surface (42A) that opposes the manipulation hole in a rectilinear range of motion of the lock lever from an unlocked position to a locked position; and a manipulated part (45), which is recessed in the opposing surface and has a blind hole shape. The manipulated part is exposed to the exterior of the housing via the manipulation hole and is engageable with a first end (J1A) of the manipulation member via the manipulation hole in the rectilinear range of motion for performing an emergency operation.

### CROSS-REFERENCE

This application claims priority to Japanese Patent Application No. 2024-104092 filed on Jun. 27, 2024, the entire contents of which are incorporated by reference as if fully set forth herein.

### TECHNICAL FIELD

The present invention relates to a vehicle door lock apparatus.

### BACKGROUND ART

One example of a known vehicle door lock apparatus is disclosed in Japanese Patent No. 6450991 and its family member US 2016/0305167. This vehicle door lock apparatus comprises a housing (case), a latch mechanism (interlocking unit assembly), an actuation mechanism (operating mechanism), and a lock mechanism.

The housing is constituted by joining together a body, a casing, and a cover member. The housing is fixed to a door that is openable and closeable relative to a vehicle body. An advancing groove (striker advancing groove) is provided in the body in a recessed or slotted manner. A striker, which is fixed to the vehicle body, is advanceable into the advancing groove.

The latch mechanism is provided inside the housing. The latch mechanism comprises a latch and a pawl. By engaging with the striker after the striker has advanced into the advancing groove, the latch mechanism is capable of holding the door in a closed state relative to the vehicle body.

The actuation mechanism is provided inside the housing. The actuation mechanism comprises a release lever, an outside lever, etc. The actuation mechanism is capable of actuating the latch mechanism.

The lock mechanism is provided inside the housing. The lock mechanism comprises a lock lever and a slide lever. The lock lever is pivotable between an unlocked position, at which actuation of the actuation mechanism is enabled, and a locked position, at which actuation of the actuation mechanism is disabled. The slide lever switches the lock lever between the unlocked position and the locked position by moving rectilinearly.

As shown in FIGS. 9 and 12-16 of US 2016/0305167, the vehicle door lock apparatus further comprises an emergency lever. The emergency lever is supported in a pivotable manner on the body of the housing and has an exposed portion that is exposed to a side surface of the advancing groove. The emergency lever comprises a first engaging part and a second engaging part. The first engaging part and the second engaging part are located within the housing and are engaged with the slide lever.

If an abnormality (fault) occurs in the electrical system of a vehicle in which this vehicle door lock apparatus is installed, security (safety) can be ensured by performing an emergency operation in the following manner. That is, with the door of the vehicle in an open state, a manipulation tool (operation tool, such as a vehicle key) is inserted into the exposed portion of the emergency lever to pivot (rotate) the emergency lever. In response to rotating of the emergency lever, the slide lever moves rectilinearly such that the lock lever switches to the locked position, thereby disabling actuation of the actuation mechanism. When the door is subsequently closed, the latch mechanism holds the door in a closed state relative to the vehicle body.

However, in the above-described known vehicle door lock apparatus, a rotation gap is formed between the emergency lever and the body of the housing, and there is a risk that water, such as rainwater or car washing water, will enter the housing through that rotation gap.

In addition, because this known vehicle door lock apparatus is designed such that the manipulation tool acts on the lock lever via the emergency lever and the slide lever in the emergency operation, the part count is relatively high.

### SUMMARY OF THE INVENTION

It is therefore one non-limiting object of the present teachings to disclose techniques for improving a vehicle door lock apparatus such as, e.g., by making it possible to disable actuation of an actuation mechanism by performing an emergency operation while also preferably curtailing (blocking) the ingress of water into a housing through a striker entry (advancing) groove (slot). Further preferably, one or both of these advantages can be achieved with a reduced part count as compared to the above-described known vehicle door lock apparatus.

In one aspect of the present teachings, a vehicle door lock apparatus of the present teachings may preferably comprise:
a housing, which is (configured to be) fixed to a door that is openable and closeable relative to a vehicle body and in which an entry groove (striker entry groove or striker receiving slot), into which a striker fixed to the vehicle body (in particular, to a vehicle door pillar) is insertable, is provided (formed) in a recessed or slotted manner;
a latch mechanism, which is provided (disposed) inside the housing and is capable of holding (configured to hold) the door in a closed state relative to the vehicle body by engaging (holding) the striker after the striker has advanced into the entry groove;
an actuation mechanism, which is provided (disposed) inside the housing and is configured to actuate (move) the latch mechanism; and
a lock lever, which is provided (disposed) inside the housing and is rectilinearly movable in a rectilinear range of motion from an unlocked position, at which actuation of the actuation mechanism is enabled, to a locked position, at which actuation of the actuation mechanism is disabled, and vice versa;
wherein:
the housing has a manipulation hole (access hole), which is formed to pass (which penetrates) through a first wall that forms a side surface of the entry groove and through which a manipulation member (tool), which is separate from the vehicle door lock apparatus, is insertable; and
the lock lever comprises:
   a second wall having an opposing surface that opposes the manipulation hole in the rectilinear range of motion; and
   a manipulated part, which is provided in a recessed manner (which is formed as a recess) in the opposing surface and has a blind hole shape, the manipulated part being exposed to the exterior of the housing (through the manipulation hole) and being engageable with a first end of the manipulation member via the manipulation hole in the rectilinear range of motion.

If an abnormality (fault) occurs in the electrical system of a vehicle in which the vehicle door lock apparatus of the above-described aspect of the present teachings is installed, security (safety) can be ensured by performing an emergency operation, e.g., in the following manner. That is, with the door of the vehicle in an open state, a tip (first) end of the manipulation member is inserted through the manipulation hole of the housing, and the first end of the manipulation member is engaged with (inserted into) the manipulated part of the lock lever to rectilinearly move the lock lever by pivoting the manipulation member. Thereby, the lock lever switches to the locked position and actuation of the actuation mechanism is disabled. When the door is subsequently closed, the latch mechanism holds the door in a closed state relative to the vehicle body.

In addition, in the present vehicle door lock apparatus, even if water such as rainwater or car washing water passes through the manipulation hole, the opposing surface of the lock lever is configured to block (and redirect) the water inside the housing and return the water to the exterior of the housing.

Furthermore, in the above-described vehicle door lock apparatus, the lock lever can be actuated (slidably moved) using only the manipulation member during an emergency operation. Therefore, the emergency lever and the slide lever according to the above-described known vehicle door lock apparatus are unnecessary.

Accordingly, in the vehicle door lock apparatus of the first aspect of the present teachings, ingress of water into the housing through the (striker) entry groove is curtailed and, at the same time, actuation of the actuation mechanism can be disabled by performing the above-described emergency operation while also achieving a reduction of the part count as compared to the above-described known vehicle door lock apparatus.

In another aspect of the present teachings, it is preferable that the rectilinear-motion direction in which the lock lever rectilinearly moves is at least substantially orthogonal (e.g., within a range of) 85-95° to the advancing-retracting direction in which the striker advances and retracts relative to the entry groove. It is preferable that one direction (a first direction, e.g., downwards) of the rectilinear-motion direction of the lock lever is the direction in which the lock lever moves from the locked position to the unlocked position. It is also preferable that the entry groove has a bottom surface located, relative to the side surface, in the one direction (the first direction, e.g., downwards) of the rectilinear-motion direction. It is preferable that the housing has a ridgeline part (e.g., a corner or edge, such as a rounded corner), which is formed on an end-edge side of the bottom surface distant (spaced apart) from the side surface (e.g., in a direction that is at least substantially orthogonal (e.g., within a range of) 85-95° to the advancing-retracting direction and the rectilinear-motion direction); the ridgeline part extends in the advancing-retracting direction. Furthermore, it is preferable that the manipulation member (tool) is capable of functioning as a lever, wherein the first end of the manipulation member engages with (is inserted into) the manipulated part of the lock lever in the unlocked position to serve as the load point (force output side of the lever), the second (opposite) end of the manipulation member serves as the effort point (force input side of the lever), and an intermediate portion of the manipulation member abuts the ridgeline part (corner of the entry groove) to serve as a fulcrum during at least a portion of pivoting movement of the manipulation member (lever) that causes the lock lever to rectilinearly move from the unlocked position to the locked position.

Thus, if the manipulation member (tool) is designed (configured) to act as a lever, the lock lever can be (manually) moved rectilinearly from the unlocked position to the locked position by manually pivoting the manipulation member (tool) more easily than in embodiments in which, hypothetically, the manipulation member is required to be moved rectilinearly to rectilinearly move the lock lever from the unlocked position to the locked position.

In another aspect of the present teachings, it is preferable that the manipulation hole has a first inner-peripheral surface, from among the inner-peripheral surfaces of the manipulation hole, that is located in the other direction (a second direction, e.g., upwards) of the rectilinear-motion direction. It is preferable that the manipulated part has a second inner-peripheral surface, from among the inner-peripheral surfaces of the manipulated part, that is located in the above-mentioned one direction (the first direction, e.g., downwards) of the rectilinear-motion direction. It is also preferable that the first inner-peripheral surface faces the one direction (the first direction, e.g., downwards) of the rectilinear-motion direction and is slanted so that it deviates (is inclined) in the other direction (the second direction, e.g., upwards) of the rectilinear-motion direction as it approaches the opposing surface of the lock lever. Furthermore, it is preferable that the second inner-peripheral surface faces the other direction (second direction, e.g., upwards) of the rectilinear-motion direction and is slanted so that is deviates (is inclined) in the one direction (the first direction, e.g., downwards) of the rectilinear-motion direction as it approaches the opposing surface of the lock lever. In other words, in the state in which the vehicle door lock apparatus is mounted on a vehicle door and the locked position of the lock lever is higher than the unlocked position of the lock lever, the first inner-peripheral surface of the manipulation hole is preferably inclined in the up-down direction such that a forward-most end of the first inner-peripheral surface of the manipulation hole is higher than a rearward-most end of the first inner-peripheral surface of the manipulation hole. Similarly, the second inner-peripheral surface of the manipulated part of the lock lever is preferably inclined in the up-down direction such that a forward-most end of the second inner-peripheral surface of the manipulated part is higher than a rearward-most end of the second inner-peripheral surface of the manipulated part. However, in an embodiment, in which the locked position of the lock lever is lower than the unlocked position of the lock lever, then each of these directions may be reversed.

In this aspect (i.e. in which the manipulation member acts as a lever), owing to the slanted first inner-peripheral surface and second inner-peripheral surface, it is made easy to ensure a sufficient stroke (movement distance) that the manipulation member can rectilinearly move the lock lever by pivoting the manipulation member relative to the lock lever to perform the emergency operation. Further, by slanting the first inner-peripheral surface and the second inner-peripheral surface in this manner, the length of the manipulation hole in the rectilinear-motion direction can be smaller because the slanted first and second inner-peripheral surfaces provide a wider (longer) pivoting range for the manipulation member in the up-down direction. As a result, by minimizing the size of the manipulation hole, the present vehicle door lock apparatus is even more capable of curtailing the problem of water penetrating into the housing through the manipulation hole and thereby affecting (e.g., corroding) the components inside the housing.

In another aspect of the present teachings, it is preferable that the advancing-retracting direction, in which the striker advances and retracts relative to the entry groove, is at least substantially horizontal (e.g., −5° to 5°) in the state in which the vehicle door lock apparatus is mounted on a door of a vehicle. It is preferable that the rectilinear-motion direction, in which the lock lever moves rectilinearly, is an up-down direction that is at least substantially orthogonal (e.g., 85-95°) to the advancing-retracting direction. It is preferable that the entry groove has: an upper restricting-end edge (upper surface) that extends parallel to the advancing-retracting direction and determines an upper-limit position of the striker after the striker has advanced into the deep interior of the entry groove; and a lower restricting-end edge (lower surface) that extends parallel to the advancing-retracting direction and determines a lower-limit position of the striker after the striker has advanced into the deep interior of the entry groove. As was noted above, the above-mentioned side surface of the entry groove is preferably spaced apart from the upper restricting-end edge (upper surface) and the lower restricting-end edge (lower surface) in a third direction that is at least substantially perpendicular (e.g., 85-95°) to the advancing-retracting direction and the up-down direction. Furthermore, it is preferable that, viewed in the direction (e.g., the third direction) in which the manipulation hole passes through the first wall, the manipulation hole is located (entirely) upward of a virtual line that extends parallel to the advancing-retracting direction at a location at which a first distance from the virtual line to the upper restricting-end edge is equal to a second distance from the virtual line to the lower restricting-end edge in the rectilinear-motion direction; i.e. the virtual line bisects the entry groove in the up-down direction and the manipulation hole is preferably disposed entirely above the virtual line.

In this aspect, water falling into the housing from above falls downward and therefore tends not to reach the side surface of the entry groove; and, even if water flows toward the side surface of the entry groove, it tends not to reach the manipulation hole, because the manipulation hole is formed (disposed) in the side surface upward of the virtual line that bisects the entry groove. As a result, the present vehicle door lock apparatus is even more capable of curtailing the ingress of water into the housing through the manipulation hole.

In another aspect of the present teachings, it is preferable that the housing has a perimeter-edge portion that is formed on the side of the first wall opposite the side surface and that surrounds the manipulation hole. Furthermore, it is preferable that the opposing surface of the lock lever also opposes the perimeter-edge portion in the rectilinear range of motion.

In this aspect, when the opposing surface of the lock lever returns (and redirects), to the exterior of the housing, water that passes through the manipulation hole, even if a portion of the water travels along the opposing surface of the lock lever and penetrates into the interior of the housing, such water can be rapidly shed downward from the opposing surface by the perimeter-edge portion. As a result, the present vehicle door lock apparatus is even more capable of curtailing the problem of water penetrating into the housing through the entry groove and thereby possibly affecting (e.g., corroding) the components in the housing.

As was noted above, it is preferable that the advancing-retracting direction, in which the striker advances and retracts relative to the entry groove (striker receiving slot), is at least substantially horizontal (−5° to 5° with respect to the horizontal or left-right direction) in the state in which the vehicle door lock apparatus is mounted on a door of a vehicle. It is also preferable that the rectilinear-motion direction, in which the lock lever moves rectilinearly, is the up-down direction, which is at least substantially orthogonal (e.g., 85-95°) to the advancing-retracting direction. Thus, in another aspect of the present teachings, it is preferable that the perimeter-edge portion has two (vertically-extending) ribs (elongated ridges) that extend in the up-down direction at locations respectively flanking the manipulation hole in the advancing-retracting direction and protrude toward the opposing surface of the lock lever. It is further preferable that two slanted ribs (elongated ribs inclined relative to the up-down direction), which are respectively connected to lower ends of the above-noted two ribs at locations downward of the manipulation hole, are slanted in a direction (e.g., a vehicle interior direction) that is on the same side of the vehicle door lock apparatus as an inlet (opening) of the entry groove in the advancing-retracting direction as they extend downward. Furthermore, it is preferable that the housing has a discharge port that allows fluid communication between the interior and the exterior of the housing (i.e. that facilitates the discharge of water out of the housing) downward of the lower ends of the slanted ribs.

In this aspect, when the opposing surface of the lock lever returns (and redirects), to the exterior of the housing, water that passes through the manipulation hole, even if a portion of the water travels along the opposing surface of the lock lever and penetrates into the interior of the housing, such water can be rapidly discharged to the exterior of the housing by the two (vertically-extending) ribs, the two slanted ribs, and the discharge port while being kept away from components within the housing.

Other aspects and advantages of the present invention will be evident from the embodiment disclosed in the following description and the accompanying drawings, the illustrations in those drawings, and the concept (gist) of the present invention disclosed in the entirety of the specification and the drawings.

### BRIEF DESCRIPTION OF THE DRAWINGS

FIG. 1 is an oblique view of a vehicle door lock apparatus according to an embodiment of the present teachings.

FIG. 2 is an exploded, oblique view of a latch housing, a latch mechanism, etc., disposed within the vehicle door lock apparatus.

FIG. 3 is a front view of a first housing, a actuation mechanism, etc., disposed within the vehicle door lock apparatus.

FIG. 4 is an exploded, oblique view of the first housing, the actuation mechanism, etc.

FIG. 5 is an oblique view of the latch housing, the latch mechanism, the actuation mechanism, etc.

FIG. 6 is an oblique view of the latch housing and a second housing.

FIG. 7 is a first schematic drawing for explaining the operation of an O/S open lever, an inertial lever, a fork, and a pawl.

FIG. 8 is a second schematic drawing for explaining the operation of the O/S open lever, the inertial lever, the fork, and the pawl.

FIG. 9 is a third schematic drawing for explaining the operation of the O/S open lever, the inertial lever, the fork, and the pawl.

FIG. 10 is a fourth schematic drawing for explaining the operation of the O/S open lever, the inertial lever, the fork, and the pawl.

FIG. 11 is a partial oblique view of the latch housing.

FIG. 12 is a partial rear view of the vehicle door lock apparatus according to the embodiment.

FIG. 13 is a partial oblique view of a lock lever.

FIGS. 14A and 14B are partial rear views of the lock lever, wherein FIG. 14A is a drawing for explaining the positional relationship between the lock lever, which is in an unlocked position, and a manipulation hole, etc., and FIG. 14B is a drawing for explaining the positional relationship between the lock lever, which is in a locked position, and the manipulation hole, etc.

FIG. 15 is a first schematic, partial, cross-sectional view for explaining an operation of moving the lock lever from the unlocked position to the locked position using a manipulation member.

FIG. 16 is a second schematic, partial, cross-sectional view for explaining the operation of moving the lock lever from the unlocked position to the locked position using the manipulation member.

FIG. 17 is a third schematic, partial, cross-sectional view for explaining the operation of moving the lock lever from the unlocked position to the locked position using the manipulation member.

### DETAILED DESCRIPTION OF THE INVENTION

A representative, non-limiting embodiment according to the present teachings is described hereinafter with reference to the drawings.

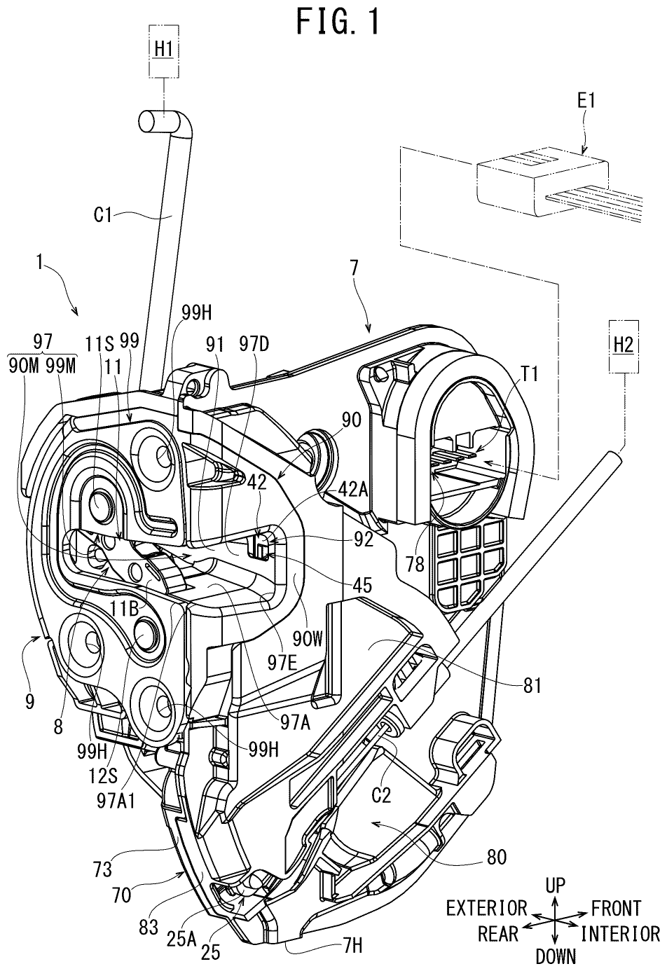

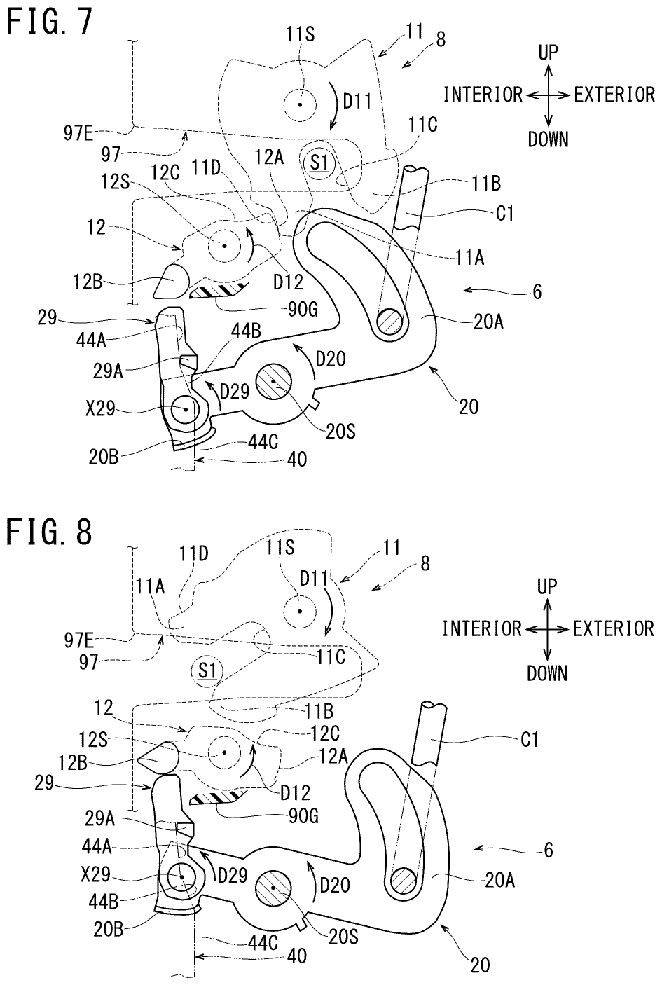

As shown in FIG. 1, vehicle door lock apparatus 1 (hereinafter, simply referred to as “door lock apparatus 1”) according to the present embodiment is one example of a specific aspect of the vehicle door lock apparatus according to the present teachings. Although not shown in the drawing, in operation, the door lock apparatus 1 is configured to be fixed to a door that is openable and closeable relative to a vehicle body of a vehicle such as an automobile, a bus, an industrial vehicle, or the like. Furthermore, the door lock apparatus 1 is capable of holding the door in a closed state relative to the vehicle body by holding (engaging) a striker S1, which is fixed to the vehicle body (see FIG. 7 to FIG. 10), in particular to a vehicle door pillar.

In FIG. 1 the door lock apparatus 1, which is provided (configured) so as to be disposed in the interior of the rear-end side of the door, which is provided on the left side of the vehicle body, is depicted. It is noted that, if the door lock apparatus 1 is fixed to the rear-end side of a door provided on the right side of the vehicle body, then it will merely be configured as a mirror image of the door lock apparatus 1 shown in the drawings. Furthermore, the door lock apparatus 1 can also be provided on a backdoor or the like, such as, e.g., a hatchback or barn door provided on the rear side of the vehicle body.

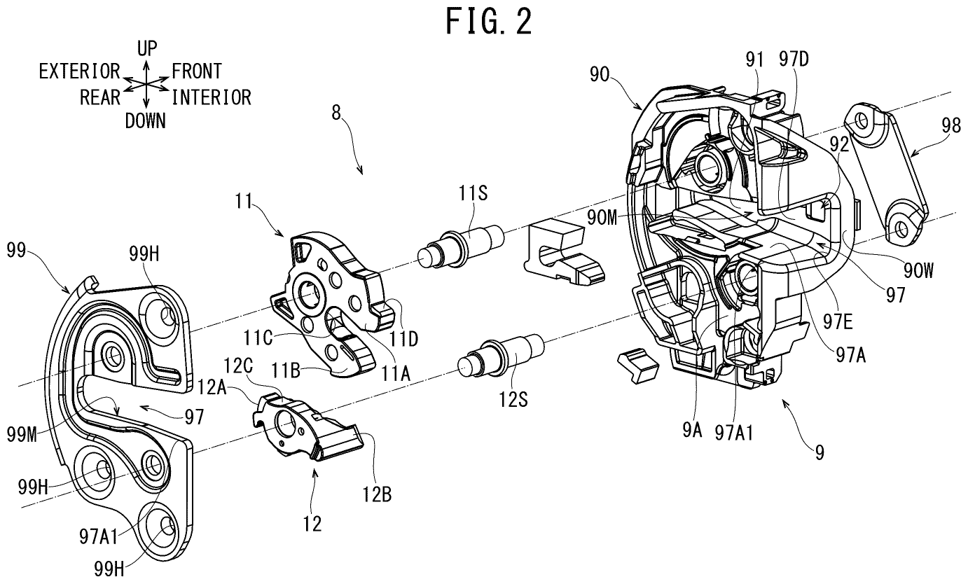

The front-rear direction and up-down direction shown in FIG. 1 are based on the front-rear direction and up-down direction of the vehicle. In addition, in a vehicle interior-exterior direction shown in FIG. 1, the left-side surface side of the vehicle, from the perspective of a person riding in the vehicle cabin of the vehicle, is the vehicle-exterior side, and the side opposite thereto is the vehicle-interior side, i.e., the vehicle-cabin side. The front-rear direction, the up-down direction, and the vehicle interior-exterior direction shown in FIG. 2 onward are displayed in correspondence with FIG. 1.

### Overall Configuration

As shown in FIG. 1, an exterior door handle H1 is provided (configured) so as to be disposed on the exterior surface of a door (not shown in the drawings), to which the door lock apparatus 1 is fixed. An interior door handle H2 is provided (configured) so as to be disposed on the interior surface of the door, which is exposed to the interior of the vehicle cabin.

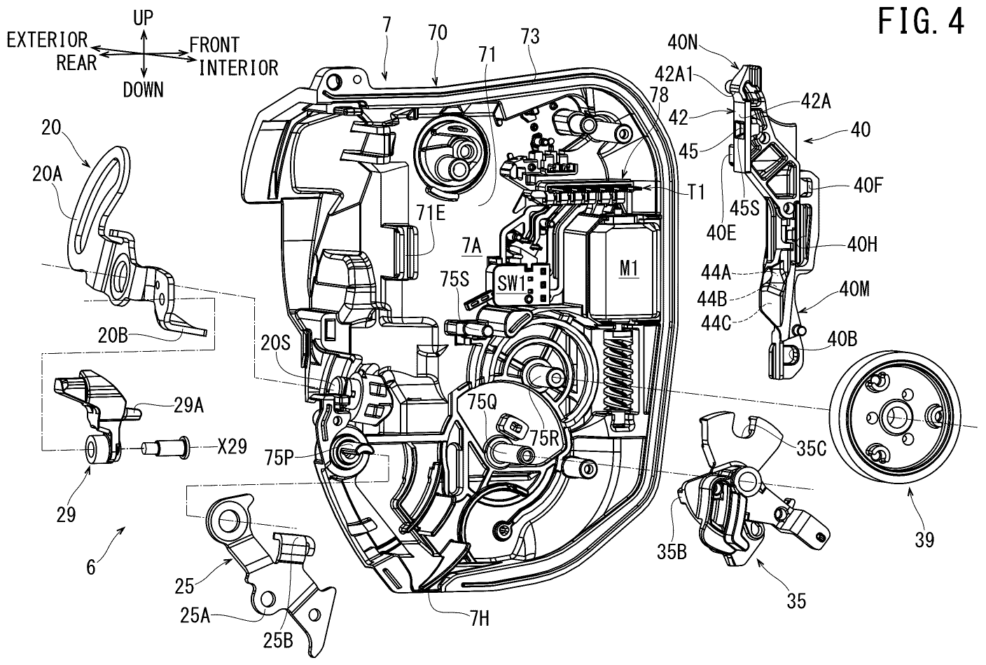

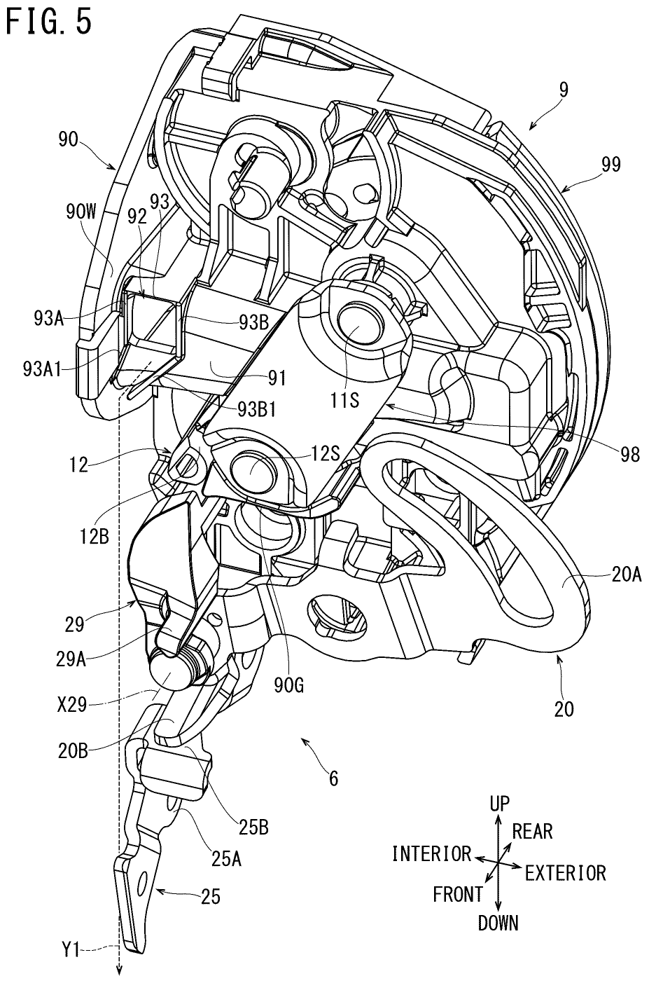

An upper-end portion of a transmission rod C1 is coupled to the exterior door handle H1. The door lock apparatus 1 is provided (configured) so as to be disposed in the interior of the door downward of the exterior door handle H1. A lower-end portion of the transmission rod C1 is coupled to a first end portion 20A of an O/S (outside) open lever 20, which will be described below with reference to FIG. 4, FIG. 5, FIG. 8, etc.

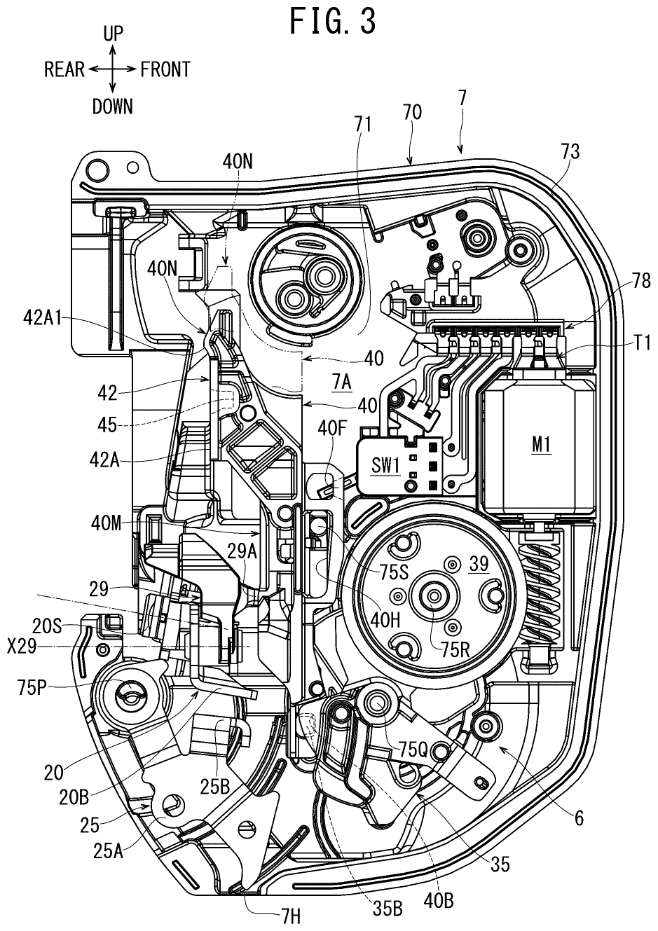

As shown in FIG. 1, a first end portion of a transmission cable C2 is connected to the interior door handle H2. The second (other, opposite) end portion of the transmission cable C2 is drawn into the door lock apparatus 1 and is connected to a first end portion 25A of an I/S (inside) open lever 25, which will be described below with reference to FIG. 3, FIG. 4, etc.

The door lock apparatus 1 comprises a latch housing 9, which is shown in FIG. 1 and FIG. 2, and an actuation housing 7, which is shown in FIG. 1 and FIG. 3. As shown in FIG. 1, the actuation housing 7 is assembled (joined, affixed) to the latch housing 9.

The latch housing 9 and the actuation housing 7 are examples of a “housing” of the present teachings.

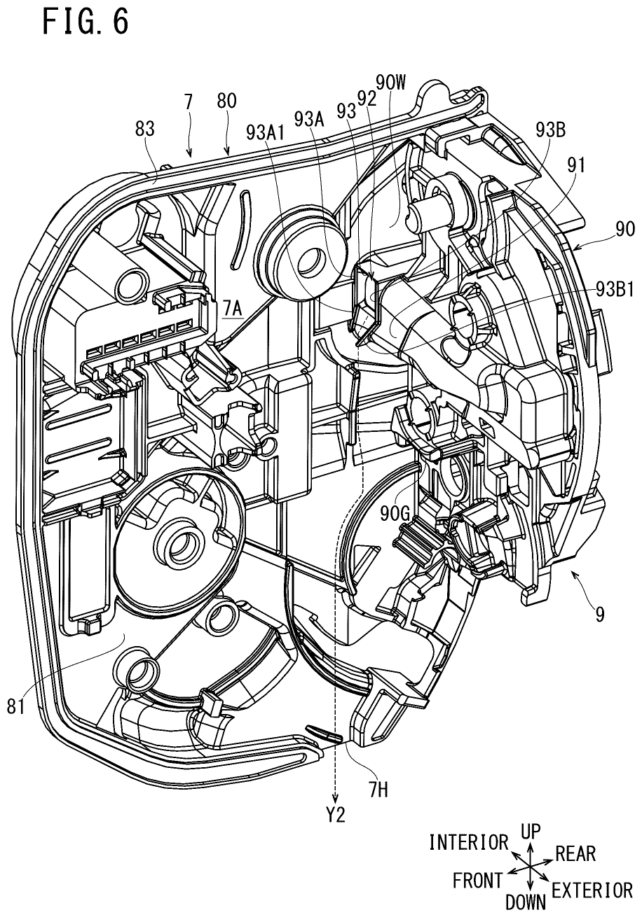

The actuation housing 7 comprises a first housing 70, which is shown in FIG. 1, FIG. 3, and FIG. 4, and a second housing 80, which is shown in FIG. 1 and FIG. 6. The first housing 70 and the second housing 80 are each made of a polymer (resin).

As shown in FIG. 3, the first housing 70 comprises a first base-wall part 71 and a first peripheral-wall part 73, which surrounds the first base-wall part 71. As shown in FIG. 6, the second housing 80 comprises a second base-wall part 81 and a second peripheral-wall part 83, which surrounds the second base-wall part 81.

The first base-wall part 71 and the second base-wall part 81 oppose each other, and the first peripheral-wall part 73 and the second peripheral-wall part 83 are welded (fused) together to assemble (join, affix) the second housing 80 to the first housing 70. A housing chamber 7A, which is shown in FIG. 3 and FIG. 4, is thereby formed (defined) in the interior of the actuation housing 7.

As shown in FIG. 2, the latch housing 9 comprises a third housing 90, which is made of a polymer (resin), and a base plate 99 and a back plate 98, which are each made from steel plates.

A fork pivot shaft 11S and a pawl pivot shaft 12S are inserted through the third housing 90, the base plate 99 is disposed rearward of the third housing 90, and the back plate 98 is disposed forward of the third housing 90. Furthermore, by riveting (upsetting, deforming) the respective rear-end portions of the fork pivot shaft 11S and the pawl pivot shaft 12S to the base plate 99 (to form a first rivet head), and by riveting (upsetting, deforming) the respective front-end portions of the fork pivot shaft 11S and the pawl pivot shaft 12S to the back plate 98 (to form a second rivet head), a latch chamber 9A is formed in the interior of the latch housing 9.

After the third housing 90 has been temporarily assembled to (mounted on) the first housing 70, the third housing 90 is joined to the first housing 70 and the second housing 80 by assembling (joining, affixing) the second housing 80 to the first housing 70, and by welding (fusing) together the first peripheral-wall part 73 of the first housing 70 and the second peripheral-wall part 83 of the second housing 80.

The door lock apparatus 1 comprises a latch mechanism 8, which is shown in FIG. 1 and FIG. 2, and an actuation mechanism 6 and a lock lever 40, which are shown in FIG. 3 and FIG. 4. The latch mechanism 8 is housed in the latch chamber 9A of the latch housing 9. The actuation mechanism 6 and the lock lever 40 are housed in the housing chamber 7A of the actuation housing 7.

As shown in FIG. 1 and FIG. 2, an entry groove (striker receiving slot or channel) 97 is provided (defined) in the latch housing 9 in a recessed or slotted manner in the vehicle exterior-interior direction. The entry groove 97 is constituted by a housing groove (slot) 90M, which is formed in the third housing 90, and a plate groove (slot) 99M, which is formed in the base plate 99.

A side surface 97D of the entry groove 97 is a side surface of the housing groove 90M; i.e. in the state in which the vehicle door is closed, the side surface 97D extends parallel to the vehicle exterior-interior direction and the up-down direction and is disposed at the deepest (forward-most) portion of the entry groove 97 in the front-rear direction. The side surface 97D of the entry groove 97 is formed by a first wall 91 of the third housing 90. The first wall 91 extends in a substantially flat-plate shape in the up-down direction and in the vehicle interior-exterior direction at a location spaced apart from and forward of the base plate 99. The side surface 97D of the entry groove 97 is a rear surface of the first wall 91. The longest (longitudinal) extension of the side surface 97D extends in the vehicle interior-exterior direction and the shortest (width) extension of the side surface 97D extends in the up-down direction.

An inlet (opening) 97E of the entry groove 97 is formed by a portion of the plate groove 99M that is open to the vehicle-interior side and a portion of the housing groove 90M that is open to the vehicle-interior side. The deep interior of the entry groove 97 is located spaced apart from the inlet 97E toward the vehicle-exterior side; i.e. the deep interior of the entry groove 97 is the end of the entry groove 97 that is closest to the vehicle exterior in the mounted state of the door lock apparatus 1 with the door in the closed state.

Fixing holes 99H are formed (defined) in the base plate 99. By inserting set screws (not shown in the drawings) through respective holes in a rear-end surface of the door and then respectively screwing them into the fixing holes 99H in the base plate 99, the latch housing 9 and the actuation housing 7 are fixed to the door in a state such that the entry groove 97 is exposed on the rear-end surface of the door.

As shown in FIG. 7 to FIG. 10, the striker S1, which is fixed to the vehicle body, advances relatively into (moves into) the entry groove 97 when the door lock apparatus 1 moves toward the vehicle-interior side as the door is closed. On the other hand, the striker S1 retracts (is withdrawn) relatively from (moves out of) the entry groove 97 when the door lock apparatus 1 moves toward the vehicle-exterior side as the door is opened.

The advancing-retracting direction, in which the striker S1 advances and retracts relative to the entry groove 97, is the vehicle interior-exterior direction and is at least substantially horizontal (e.g., −5° to 5° with respect to the horizontal direction of the vehicle), more preferably horizontal, in the state that the vehicle door lock apparatus 1 is mounted on the vehicle.

As shown in FIG. 2, the latch mechanism 8 comprises a fork 11 and a pawl 12. The fork 11 is supported on (by) the fork pivot shaft 11S, which is located upward of the entry groove 97, in a pivotable manner. The pawl 12 is supported on (by) the pawl pivot shaft 12S, which is located downward of the entry groove 97, in a pivotable manner.

As shown in FIG. 7 to FIG. 10, the fork 11 is biased by a torsion spring (not shown in the drawings) to pivot about the fork pivot shaft 11S in (rotational) direction D11.

The region (portion) of the fork 11 that is located on the entry groove 97 side forks (branches) into an interior protruding portion 11A and an exterior protruding portion 11B. Furthermore, the striker S1 is designed to fit, after it has advanced into the entry groove 97, into a notched portion 11C formed between the interior protruding portion 11A and the exterior protruding portion 11B.

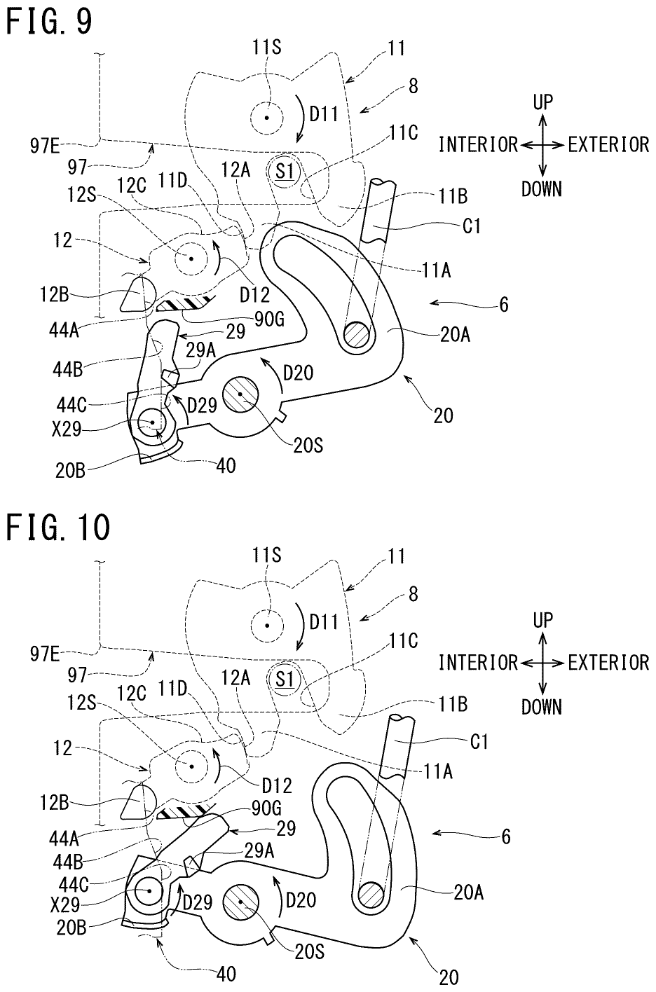

In the states shown in FIG. 7, FIG. 9, and FIG. 10, the fork 11 holds the striker S1, which has advanced into the deep interior of the entry groove 97. A latch surface 11D, which is configured to abut on a stopper surface 12A (described below), is formed (defined) on a tip side of the interior protruding portion 11A that faces the pawl 12.

The pawl 12 is biased by a torsion spring (not shown in the drawings) to pivot about the pawl pivot shaft 12S in (rotational) direction D12 and hold the attitude shown in FIG. 7.

The stopper surface 12A is formed on the pawl 12 at a region that is located in the deep interior of the entry groove 97. The stopper surface 12A is formed so as to face the latch surface 11D described above. An arc constituting the stopper surface 12A is interrupted on the fork 11 side, and, from there, a sliding surface 12C extending toward the pawl pivot shaft 12S side is formed.

On the other side, an abutted part 12B is formed on the side of the pawl 12 that is opposite the stopper surface 12A, with the pawl pivot shaft 12S being sandwiched therebetween. As shown in FIG. 2, the abutted part 12B projects forward in a columnar shape. As shown in FIG. 5, the front end of the abutted part 12B projects forward from the latch chamber 9A through the third housing 90 and penetrates into the housing chamber 7A.

As shown in FIG. 7, in the state in which the fork 11 is holding the striker S1, which has advanced into the deep interior of the entry groove 97, the stopper surface 12A abuts the latch surface 11D of the interior protruding portion 11A, and the pawl 12 thereby fixes the fork 11 so that the fork 11 is not pivotable in the D11 direction. The position of the fork 11 shown in FIG. 7 is a latched position that holds the striker S1 within the entry groove 97.

As shown in FIG. 8, when an inertial lever 29, to be described below, abuts and pushes the abutted part 12B of the pawl 12 upward, the pawl 12 pivots about the pawl pivot shaft 12S in the reverse direction of the D12 direction against the biasing force of a torsion spring, which is not shown in the drawings. At this time, the stopper surface 12A separates from the latch surface 11D, and the pawl 12 thereby releases the fork 11 such that the fork 11 becomes pivotably again. The fork 11 then pivots about the fork pivot shaft 11S in the D11 direction owing to the biasing force of the torsion spring, which is not shown in the drawings, thereby shifting the fork 11 to an unlatched position that allows the striker S1 to be retracted (withdrawn) from the interior of the entry groove 97.

Conversely, when the striker S1 advances into the entry groove 97, the striker S1 pushes the exterior protruding portion 11B, thereby causing the fork 11 to pivot in the reverse direction of the D11 direction and return from the unlatched position shown in FIG. 8 to the latched position shown in FIG. 7. At this time, the tips of the exterior protruding portion 11B and the interior protruding portion 11A successively contact the sliding surface 12C in a sliding manner. Then, when the interior protruding portion 11A separates from the sliding surface 12C, the pawl 12 pivots in the D12 direction to return to the original attitude shown in FIG. 7. Consequently, the stopper surface 12A abuts the latch surface 11D, and pivoting of the fork 11 is fixed (blocked) in the latched position. In this manner, the latch mechanism 8 holds the door in a closed state relative to the vehicle body by engaging with (holding) the striker S1, which has advanced into the entry groove 97.

As shown in FIG. 3 and FIG. 4, the actuation mechanism 6 comprises the O/S (outside) open lever 20, the I/S (inside) open lever 25, the inertial lever 29, an intermediate lock lever 35, an electric motor M1, a worm wheel 39, and a switch SW1.

In the first housing 70, an O/S-open-lever pivot shaft 20S is provided facing rearward in a protruding manner at a rearward and downward region of the first base-wall part 71. The O/S open lever 20 is supported on the O/S-open-lever pivot shaft 20S in a pivotable manner.

As shown in FIG. 7, the O/S open lever 20 is biased by a torsion spring (not shown in the drawings) to pivot about the O/S-open-lever pivot shaft 20S in (rotational) direction D20. Although not shown in the drawings, the first end portion 20A of the O/S open lever 20, to which a lower-end portion of the transmission rod C1 is connected, protrudes to the exterior of the actuation housing 7.

As shown in FIG. 3 to FIG. 5, the inertial lever 29 is supported on the second end portion 20B of the O/S open lever 20 in a manner to be pivotable about pivot axis X29, which extends in the front-rear direction when the door lock apparatus 1 is mounted on a vehicle door that is in the closed stated with respect to the vehicle body. As shown in FIG. 7, the inertial lever 29 is biased by a torsion spring, which is not shown in the drawings, to pivot about pivot axis X29 in (rotational) direction D29.

When an unlock operation is performed on the exterior door handle H1 (i.e. the exterior door handle H11 is manually pulled) and the transmission rod C1 thereby descends, as shown in FIG. 8, the first end portion 20A of the O/S open lever 20 is pushed down, causing the O/S open lever 20 to pivot in the reverse direction of the D20 direction and raise the inertial lever 29.

A first shaft part 75P is formed at a rearward and downward region of the first base-wall part 71 of the first housing 70, as shown in FIG. 3 and FIG. 4. A second shaft part 75Q is formed at a region of the first base-wall part 71 that is forward of the first shaft part 75P. A third shaft part 75R and a fourth shaft part 75S are formed at a region that is located substantially in the center of the first base-wall part 71. The first shaft part 75P, the second shaft part 75Q, the third shaft part 75R, and the fourth shaft part 75S each extend toward the second base-wall part 81 of the second housing 80.

The I/S open lever 25 is supported on (by) the first shaft part 75P in a pivotable manner. The second end portion of the transmission cable C2 is coupled to the first end portion 25A of the I/S open lever 25, the first end portion 25A being spaced apart downward from the first shaft part 75P. In other words, the I/S open lever 25 is coupled to the interior door handle H2 via the transmission cable C2.

An actuating portion 25B is formed at a region that is upward of the first end portion 25A of the I/S open lever 25. In response to an unlock operation being performed on the interior door handle H2 (i.e. the interior door handle H2 is manually pulled), the I/S open lever 25 pivots in the counterclockwise direction toward the paper plane in FIG. 3. The actuating portion 25B thereby lifts up the second end portion 20B of the O/S open lever 20 and raises the inertial lever 29. Although description thereof will be omitted, the I/S open lever 25 also functions (a so-called override function) to make the door openable in a situation in which an unlock operation is performed only on the interior door handle H2 with the door in a locked state, whereby the I/S open lever 25 acts on the intermediate lock lever 35 to put the door lock apparatus 1 in an unlocked state.

As shown in FIG. 3 and FIG. 4, the intermediate lock lever 35 is supported on (by) the second shaft part 75Q in a pivotable manner. As shown in FIG. 4, a cam 35C is formed on an upper portion of the intermediate lock lever 35. An actuating portion 35B protruding toward the vehicle-exterior side is provided (defined) on a surface of the intermediate lock lever 35 that faces the vehicle-exterior side.

As shown in FIG. 3 and FIG. 4, the worm wheel 39 is supported on (by) the third shaft part 75R in a pivotable manner. A cam part (not shown in the drawings), which is engageable with the cam 35C of the intermediate lock lever 35, is formed (defined) on a surface of the worm wheel 39 that faces the vehicle-exterior side.

The electric motor M1 is disposed at a location inside the housing chamber 7A that is upward and forward of the worm wheel 39. The worm wheel 39 meshes with a worm gear fixed to a rotary shaft of the electric motor M1.

A terminal-holding part 78, which holds a plurality of connection terminals T1, is provided inside the housing chamber 7A upward of the electric motor M1. Two of the connection terminals T1 are connected to the electric motor M1. When door lock/unlock control is electronically performed, electric power is supplied from an electric-power supply (not shown in the drawings), e.g., a vehicle battery, provided in the vehicle body to the electric motor M1 via an exterior connector E1, which is shown in FIG. 1, and the two connection terminals T1.

When the electric motor M1 is electronically actuated by a lock operation or an unlock operation being performed using a remote-control key, a fob, an app on a smart phone, or the like, the worm wheel 39 is rotationally driven by the electric motor M1 to rotate in the clockwise direction or the counterclockwise direction toward the paper plane in FIG. 3. Then, by engaging the cam part of the worm wheel 39 with the cam 35C of the intermediate lock lever 35, the worm wheel 39 shifts the intermediate lock lever 35 between the position shown in FIG. 3 and a position, not shown in FIG. 3, that is reached by pivoting in the clockwise direction within the paper plane from the position shown in FIG. 3.

As shown in FIG. 3 and FIG. 4, the lock lever 40 has a main-body portion 40M and an extension portion 40N. The main-body portion 40M extends in the up-down direction. A lower end of the extension portion 40N is connected to an upper end of the main-body portion 40M. The extension portion 40N extends obliquely upward and rearward from the lower end thereof, then bends to extend upward.

A slot 40H extending in the up-down direction is formed in the main-body portion 40M. A recessed portion (recess) 40B is provided in a recessed manner in a lower-end portion of the main-body portion 40M. A switch-manipulation portion 40F is formed upward of the slot 40H of the main-body portion 40M.

As shown in FIG. 4, a rectilinear-motion protruding portion 40E, which protrudes toward the vehicle-exterior side, is provided on the lower-end side of the upwardly extending portion of the extension portion 40N.

A rectilinear-motion groove portion 71E is formed in a region of the first base-wall part 71 of the first housing 70 that is rearward and upward of the fourth shaft part 75S. The rectilinear-motion protruding portion 40E is disposed inside the rectilinear-motion groove portion 71E. The rectilinear-motion protruding portion 40E is guided in the up-down direction by the rectilinear-motion groove portion 71E. As shown in FIG. 3, the fourth shaft part 75S is inserted through the slot 40H. The slot 40H is guided in the up-down direction by the fourth shaft part 75S.

In this manner, the lock lever 40 is rectilinearly movable, in the up-down direction within the housing chamber 7A, between the unlocked position indicated by the solid line in FIG. 3 and the locked position indicated by the chain, double-dashed line in FIG. 3.

The rectilinear-motion direction (up-down direction), in which the lock lever 40 rectilinearly moves, is at least substantially orthogonal (e.g., 85-95°) to the advancing-retracting direction (the vehicle interior-exterior direction), in which the striker S1 advances and retracts relative to the entry groove 97.

The actuating portion 35B of the intermediate lock lever 35 is engaged with the recessed portion 40B of the lock lever 40. A lever of the switch SW1 is engaged with the switch-manipulation portion 40F of the lock lever 40.

Three of the connection terminals T1, which are different from the two connection terminals T1 connected to the electric motor M1, are connected to the switch SW1. In the state in which the lock lever 40 is in the unlocked position indicated by the solid line in FIG. 3, the lock lever 40 turns ON one contact point in the switch SW1. When the lock lever 40 is rectilinearly moved upward and shifted from the unlocked position to the locked position indicated by the chain, double-dashed line in FIG. 3, the lock lever 40 turns ON another contact point in the switch SW1. An ON/OFF signal of the two contact points in the switch SW1 is transmitted via the three connection terminals T1 and the exterior connector E1 to a control part, such as a vehicle electronic control unit (ECU), which is not shown in the drawings, which is provided in the vehicle body, and is used to perform electronic door lock/unlock control and ascertain the state of the door lock apparatus 1.

The lock lever 40 is moved rectilinearly in response to electronic lock operations and unlock operations using a remote-control key, a fob, an app on a smart phone, or the like, as described below.

When the rotor of the electric motor M1 rotates and the intermediate lock lever 35 is thereby pivoted in the clockwise direction within the paper plane, in response to a lock operation using the remote-control key, the fob, the app on the smart phone, or the like, from the position shown in FIG. 3, the shifting thereof is transmitted to the lock lever 40 via the recessed portion 40B and the actuating portion 35B. Consequently, the lock lever 40 is pushed up from the unlocked position indicated by the solid line in FIG. 3 to the locked position indicated by the chain, double-dashed line in FIG. 3.

Conversely, when the rotor of the electric motor M1 rotates in the opposite direction in response to a unlock operation using the remote-control key, the fob, the app on a smart phone, or the like, the intermediate lock lever 35 returns to the position shown in FIG. 3, and the shifting thereof is transmitted to the lock lever 40 via the recessed portion 40B and the actuating portion 35B. Consequently, the lock lever 40 is pulled down from the locked position indicated by the chain, double-dashed line in FIG. 3 to the unlocked position indicated by the solid line in FIG. 3.

As shown in FIG. 3, FIG. 4, and FIG. 7, a first surface 44A, a second surface 44B, and a third surface 44C are formed on the main-body portion 40M between the slot 40H and the recessed portion 40B. The first surface 44A, the second surface 44B, and the third surface 44C are formed on a surface of the lock lever 40 that faces the vehicle-exterior side.

The first surface 44A and the third surface 44C are flat surfaces that extend in the up-down direction, and the first surface 44A is offset further to the vehicle-interior side than the third surface 44C. The second surface 44B is a slanted surface connected to the lower end of the first surface 44A and the upper end of the third surface 44C.

As shown in FIG. 3 to FIG. 5 and FIG. 7, a protruding portion 29A, which protrudes forward, is provided on a front surface of the inertial lever 29. The protruding portion 29A contacts the first surface 44A, the second surface 44B, and the third surface 44C in a sliding manner in response to the actuation of the lock lever 40. That is, the protruding portion 29A slides along the first surface 44A, the second surface 44B, and the third surface 44C in that order in response to the actuation (rectilinear movement) of the lock lever 40.

As shown in FIG. 5 and FIG. 7, an inertial-lever guide surface 90G is formed (defined) on the housing chamber 7A side of the third housing 90. The inertial-lever guide surface 90G is a downward-facing flat surface located further to the vehicle-exterior side than the abutted part 12B of the pawl 12. The inertial-lever guide surface 90G extends toward the vehicle-exterior side away from the abutted part 12B.

As shown in FIG. 7, the inertial-lever guide surface 90G is located slightly downward of the lower end of the abutted part 12B. In the state in which the O/S open lever 20 is not pivoting, the inertial-lever guide surface 90G is located upward of the upper end of the inertial lever 29.

The position of the lock lever 40 shown in FIG. 7 and FIG. 8 is the same unlocked position as that of the lock lever 40 indicated by the solid line in FIG. 3. The position of the lock lever 40 shown in FIG. 9 and FIG. 10 is the same locked position as that of the lock lever 40 indicated by the chain, double-dashed line in FIG. 3.

In the state in which the lock lever 40 is in the unlocked position, as shown in FIG. 7, the inertial lever 29 is held in an upward-standing state owing to the protruding portion 29A of the inertial lever 29 abutting the first surface 44A of the lock lever 40. In this state, if the inertial lever 29 rises in response to a manual unlock operation being performed on the exterior door handle H1 or a manual unlock operation being performed on the interior door handle H2, as shown in FIG. 8, then the inertial lever 29 abuts the abutted part 12B and causes the pawl 12 to release the fork 11.

In other words, the actuation mechanism 6 is configured to actuate the latch mechanism 8. The unlocked position of the lock lever 40 is a position at which actuation of the actuation mechanism 6 is enabled.

Conversely, when the lock lever 40 is shifted to the locked position, as shown in FIG. 9, the protruding portion 29A of the inertial lever 29 contacts the second surface 44B of the lock lever 40 in a sliding manner and then abuts the third surface 44C. As a result, the inertial lever 29 is held in a state in which it is slanted toward the vehicle-exterior side. In this state, if the inertial lever 29 rises in response to a manual unlock operation being performed on the exterior door handle H1, as shown in FIG. 10, then the inertial lever 29 abuts the inertial-lever guide surface 90G and becomes spaced apart from the abutted part 12B; thus, the pawl 12 remains in the state in which the pawl 12 fixes (blocks pivoting of) the fork 11.

In other words, the locked position of the lock lever 40 is a position at which actuation of the actuation mechanism 6 is disabled.

In this manner, the door lock apparatus 1 is capable, in response to various types of operations performed by passengers in the vehicle, of holding the door in a closed state relative to the vehicle body, opening the door, and locking or unlocking the door in a closed state.

Configuration of a Manipulation Hole in the Latch Housing, a Manipulated Part of the Lock Lever, etc.

To perform an emergency operation to ensure security (safety) in the situation in which an abnormality (fault) has occurred in the electrical system of the vehicle, the door lock apparatus 1 is preferably configured in the following manner.

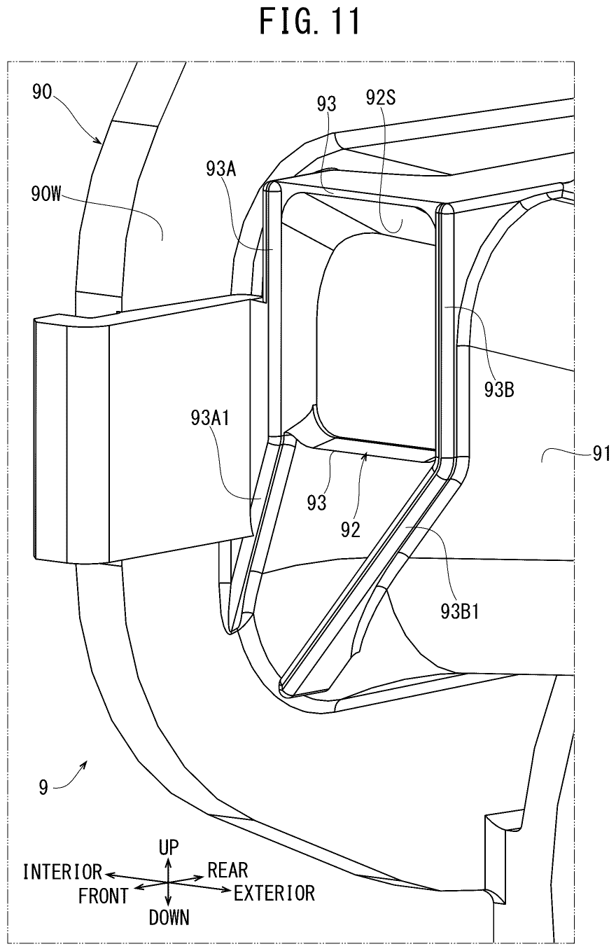

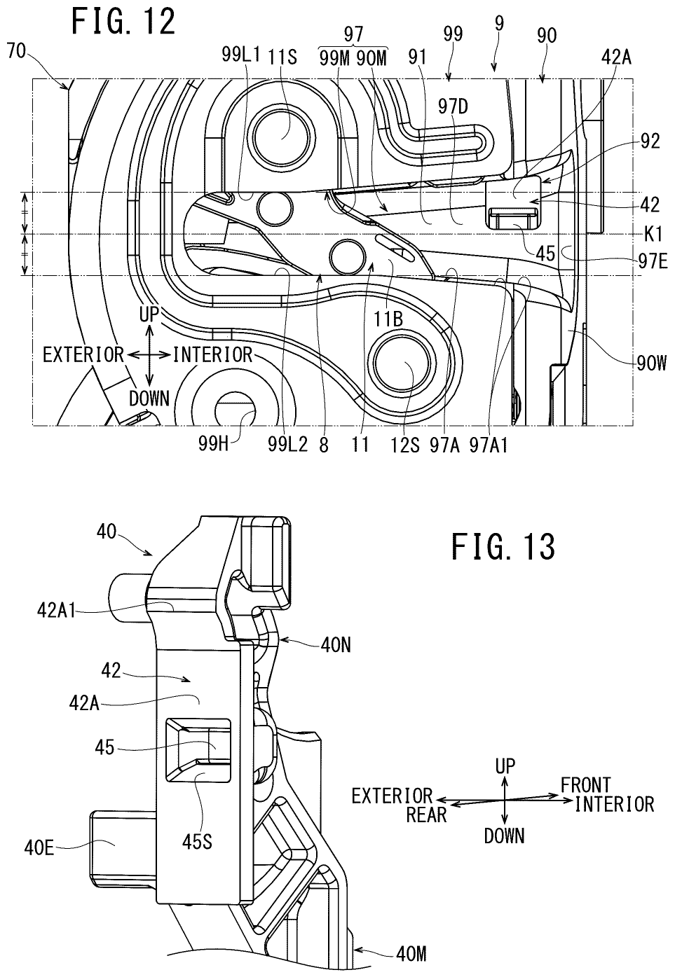

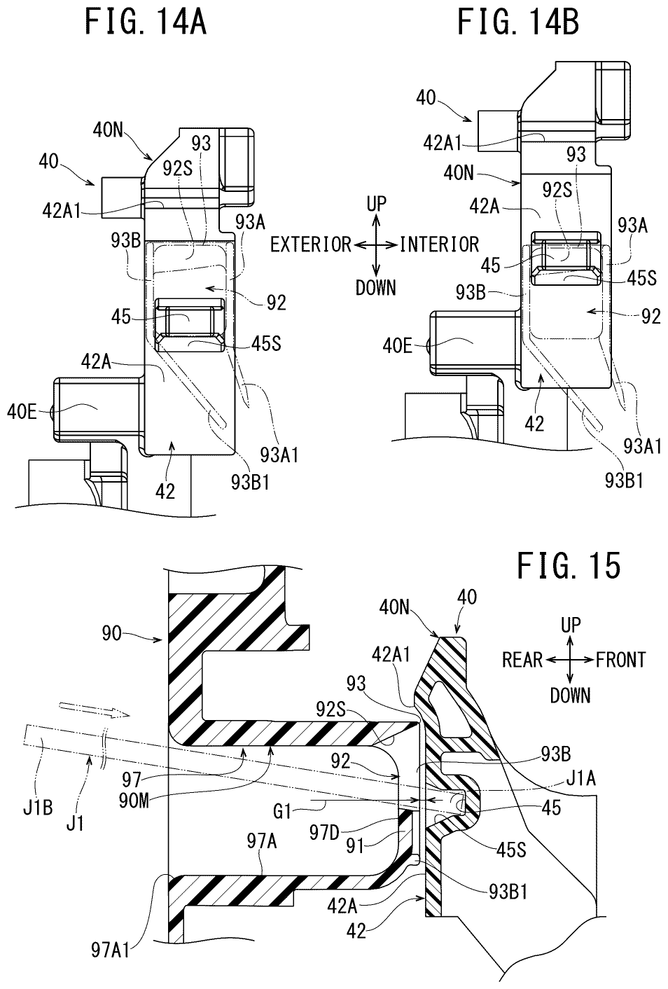

As shown in FIG. 1, FIG. 2, FIG. 5, FIG. 6, FIG. 11, FIG. 12, and FIG. 14A to FIG. 17, the third housing 90 of the latch housing 9 has a manipulation hole (access hole) 92. As shown in FIG. 1, FIG. 3, FIG. 4, and FIG. 12 to FIG. 17, the lock lever 40 comprises a second wall 42 and a manipulated part (blind hole, depression) 45.

### Manipulation Hole

As shown in FIG. 2, FIG. 11, and FIG. 12, the manipulation hole 92 is formed in (extends through) the first wall 91 of the third housing 90; i.e. the manipulation hole 92 is a through hole. The manipulation hole 92 passes, in the front-rear direction, through the first wall 91 on the inlet 97E side of the entry groove 97. The manipulation hole 92 is a generally rectangular hole with four rounded corners.

As shown in FIG. 1, the third housing 90 comprises a third wall 90W. The third wall 90W has a substantially flat-plate shape that surrounds the inlet 97E of the entry groove 97 from the front, from above, and from below. The third wall 90W extends in the up-down direction and the front-rear direction and is joined together with the second housing 80. The manipulation hole 92 is located in the vicinity of the third wall 90W.

As shown in FIG. 12, the entry groove 97 comprises an upper restricting-end edge (upper edge or surface) 99L1 and a lower restricting-end edge (lower edge or surface) 99L2 in the up-down direction. The upper restricting-end edge 99L1 and the lower restricting-end edge 99L2 are formed on the plate groove 99M of the base plate 99.

The upper restricting-end edge 99L1 is positioned in the deep interior of the entry groove 97 and extends parallel to the advancing-retracting direction of the striker S1, i.e., at least substantially horizontally. The upper restricting-end edge 99L1 determines an upper-limit position of the striker S1 after it has advanced into the deep interior of the entry groove 97.

The lower restricting-end edge 99L2 is also located in the deep interior of the entry groove 97, is spaced apart downward from the upper restricting-end edge 99L1, and also extends parallel to the advancing-retracting direction of the striker S1, i.e., at least substantially horizontally. The lower restricting-end edge 99L2 determines a lower-limit position of the striker S1 after it has advanced into the deep interior of the entry groove 97.

Virtual line K1 is defined as a straight line that extends parallel to the advancing-retracting direction of the striker S1 (the vehicle interior-exterior direction) at a location at which the distance from virtual line K1 to the upper restricting-end edge 99L1 is equal to the distance from virtual line K1 to the lower restricting-end edge 99L2 in the rectilinear-motion direction of the lock lever 40 (the up-down direction); i.e. virtual line K1 bisects the entry groove 97 in the up-down direction.

Viewed in the front-rear direction in which the manipulation hole 92 passes through the first wall 91, the manipulation hole 92 is positioned entirely upward of virtual line K1.

As shown in FIG. 11 and FIG. 15, the manipulation hole 92 has, in particular, a first inner-peripheral surface 92S. From among the four inner-peripheral surfaces of the manipulation hole 92, the first inner-peripheral surface 92S is the inner-peripheral surface that is located most upward and extends in the vehicle interior-exterior direction and in the front-rear direction in the mounted state of the door lock apparatus 1. The first inner-peripheral surface 92S faces downward and is slanted so that it deviates (is inclined) upward as it extends forward in the front-rear direction so as to approach an opposing surface 42A of the lock lever 40, to be described below.

As shown in FIG. 15 to FIG. 17, a manipulation member (tool) J1, which is separate from the door lock apparatus 1, is insertable through the manipulation hole 92. The manipulation member J1 may have any shape as long as it can be, for example, carried by a user of the vehicle or housed in the vehicle, and has a first end JIA, which is insertable through the manipulation hole 92, and a second end J1B, which is grippable by the user. The manipulation member J1 preferably has an elongate shape, such as a rod shape (e.g., a circular cylinder shape or a polygonal cylinder shape that has a greater length than width or diameter, preferably having a length: width/diameter (aspect) ratio of, e.g., at least 5:1 or at least 10:1) or an elongated plate shape, and can be, for example, a vehicle key, an in-vehicle tool, or the like.

As shown in FIG. 11, the third housing 90 has a perimeter-edge portion 93. The perimeter-edge portion 93 is formed on the side of the first wall 91 opposite the side surface 97D, i.e., on the front-surface side of the first wall 91. The perimeter-edge portion 93 surrounds the four sides of the manipulation hole 92. The perimeter-edge portion 93 comprises two (first and second) ribs (elongated ridges) 93A, 93B.

The (first) rib 93A extends in the up-down direction adjacent to one side of the manipulation hole 92 that extends in the up-down direction on the vehicle-interior side and projects forward toward the opposing surface 42A of the lock lever 40.

The (second) rib 93B extends in the up-down direction adjacent to the other side of the manipulation hole 92 that extends in the up-down direction on the vehicle-exterior side and projects forward toward the opposing surface 42A.

Thus, the ribs 93A, 93B are provided at locations that respectively flank the manipulation hole 92 in the advancing-retracting direction of the striker S1 and extend parallel to each other.

A (first) slanted rib 93A1 is connected to the lower end of the (first) rib 93A, which is located downward of the manipulation hole 92. The slanted rib 93A1 is slanted so as to approach the side of the inlet 97E of the entry groove 97 in the vehicle interior-exterior direction as it advances (extends) downward, i.e., so as to approach the third wall 90W. The lower end of the slanted rib 93A1 is connected to the third wall 90W.

A (second) slanted rib 93B1 is connected to the lower end of the (second) rib 93B, which is also located downward of the manipulation hole 92. The slanted rib 93B1 is slanted so as to approach the side of the inlet 97E of the entry groove 97 in the vehicle interior-exterior direction as it advances (extends) downward, i.e., so as to approach the third wall 90W. The lower end of the slanted rib 93B1 is located downward of the lower end of the slanted rib 93A1 and there is a small gap between it and the third wall 90W.

As shown in FIG. 1, FIG. 4, and FIG. 6, the actuation housing 7 has a discharge port 7H. The discharge port 7H is formed (defined) by a (first) notch formed (defined) in the lower end of the first peripheral-wall part 73 of the first housing 70 and a (second) notch formed (defined) in the lower end of the second peripheral-wall part 83 of the second housing 80.

As shown in FIG. 6, the discharge port 7H allows (enables) fluid communication between the interior and the exterior of the actuation housing 7 downward of the lower ends of the slanted ribs 93A1, 93B1.

### Second Wall and Manipulated Part

As shown in FIG. 13 and FIGS. 14A-14B, the second wall 42 is formed on the rear-end side of the upwardly extending portion of the extension portion 40N of the lock lever 40. The second wall 42 has a substantially flat-plate shape that extends in the up-down direction and in the vehicle interior-exterior direction.

The second wall 42 includes the opposing surface 42A of the lock lever 40. The opposing surface 42A is the rear surface of the second wall 42. The opposing surface 42A is a generally flat surface that extends in the up-down direction and in the vehicle interior-exterior direction. The opposing surface 42A has an upper end 42A1 at the upper portion thereof. The opposing surface 42A curves rearward at the upper end 42A1.

As shown in FIGS. 14A and 14B, the length of the opposing surface 42A in the vehicle interior-exterior direction is greater than the opening width of the manipulation hole 92 in the vehicle interior-exterior direction and is greater than the outer widths of the perimeter-edge portion 93 and the ribs 93A, 93B in the vehicle interior-exterior direction.

FIG. 14A and FIG. 15 show the lower limit of the rectilinear range of motion of the lock lever 40 from the unlocked position to the locked position. In this state, the upper end 42A1 of the opposing surface 42A is located upward of the manipulation hole 92, the perimeter-edge portion 93, and the ribs 93A, 93B, whereas the lower end of the opposing surface 42A is located downward of the manipulation hole 92, the perimeter-edge portion 93, and the ribs 93A, 93B.

FIG. 14B and FIG. 17 show the upper limit of the rectilinear range of motion of the lock lever 40 from the unlocked position to the locked position. In this state as well, the upper end 42A1 of the opposing surface 42A is located upward of the manipulation hole 92, the perimeter-edge portion 93, and the ribs 93A, 93B, whereas the lower end of the opposing surface 42A is located downward of the manipulation hole 92, the perimeter-edge portion 93, and the ribs 93A, 93B.

In other words, the opposing surface 42A opposes the manipulation hole 92, the perimeter-edge portion 93, and the ribs 93A, 93B in the rectilinear range of motion of the lock lever 40 from the unlocked position to the locked position.

As shown in FIG. 15, a gap G1 in the front-rear direction between the opposing surface 42A and the ribs 93A, 93B is set as small as possible within a range such that the rectilinear motion of the lock lever 40 is not affected. As one example in the present embodiment, the gap G1 is in the order of several hundred micrometers (e.g., 200-800 μm).

The manipulated part 45 is provided in (on) the opposing surface 42A in a recessed manner. The manipulated part 45 has a blind hole shape (e.g., it may be configured as a depression in the opposing surface 42A) and is recessed facing forward at a location substantially in the center of the opposing surface 42A. The manipulated part 45 preferably has an at least substantially rectangular shape, viewed in the front-rear direction.

As shown in FIG. 14A to FIG. 17, the manipulated part 45 is exposed to the exterior of the latch housing 9 and the actuation housing 7 (through the manipulation hole 92) and is engageable with the first end JIA of the manipulation member J1 through the manipulation hole 92 in the rectilinear range of motion of the lock lever 40 from the unlocked position to the locked position.

One direction (first direction) of the rectilinear-motion direction of the lock lever 40 is the direction in which the lock lever 40 moves from the locked position to the unlocked position, i.e., downward. The other (opposite) direction (second direction) of the rectilinear-motion direction of the lock lever 40 is thus upward.

The manipulated part 45 has a second inner-peripheral surface 45S. The second inner-peripheral surface 45S is an inner-peripheral surface that is located at (on) the lower portion of the inner-peripheral surface of the manipulated part 45 and extends in the vehicle interior-exterior direction and the front-rear direction in the mounted state of the door lock apparatus 1. The second inner-peripheral surface 45S faces upward and is slanted so that it deviates (is inclined) downward as it extends rearward so as to approach the opposing surface 42A and the manipulation hole 92.

As shown in FIG. 1, the entry groove 97 has a bottom surface 97A. The bottom surface 97A is formed by a side surface, which is located downward relative to the side surface 97D of the housing groove 90M, and by a lower-side end surface, which includes the lower restricting-end edge 99L2 of the plate groove 99M. In other words, the bottom surface 97A is located downward relative to the side surface 97D.

The latch housing 9 comprises a ridgeline part (ridge, rounded corner edge) 97A1. The ridgeline part 97A1 is formed on an end-edge side of the bottom surface 97A that is distant (spaced apart) from the side surface 97D. As shown in FIG. 12, the ridgeline part 97A1 is located directly below the manipulation hole 92 and extends along the advancing-retracting direction of the striker S1, i.e., along the vehicle interior-exterior direction.

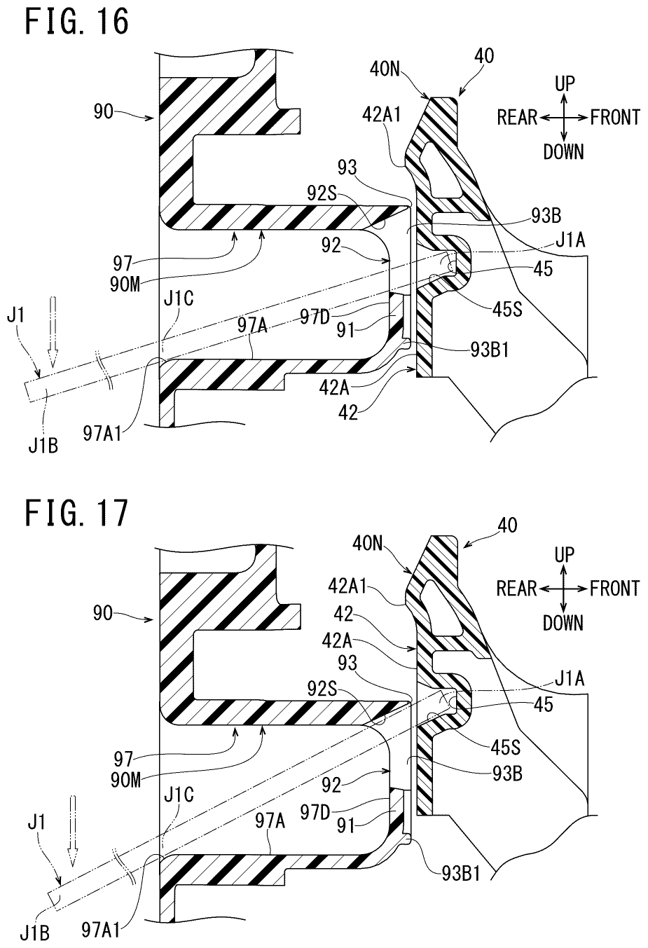

As shown in FIG. 16 and FIG. 17, the manipulation member J1 is configured to act as a lever, wherein the first end JIA engages with (in) the manipulated part 45 of the lock lever 40 in the unlocked position to serve as the load point (lever output), the second end JIB serves as the effort point (lever input), and an intermediate portion J1C abuts the ridgeline part 97A1 to serve as a fulcrum for the final phase of the pivoting movement of the manipulation member J1. Thus, as will be further explained below, the lock lever 40 can be moved upward in a rectilinear manner from the unlocked position to the locked position by manually moving the second end JIB of the manipulation member J1 in the direction from upward (FIG. 15) to downward (FIG. 17) to thereby first pivot the manipulation member J1 about the lower edge of the manipulation hole 92 (which serves as a first fulcrum) and then subsequently pivoting the manipulation member J1 about the ridgeline part 97A1 (which serves as a second fulcrum) and thus move the first end JIA (and thereby the lock lever 40) upwardly.

### Functions and Effects

If an abnormality (fault) occurs in the electrical system of a vehicle in which the door lock apparatus 1 according to the present embodiment is installed, security (safety) can be ensured by performing an emergency operation such as in the following manner.

That is, as shown in FIG. 15, with the door of the vehicle in an open state, the user grips the second end JIB of the manipulation member J1, inserts the first end JIA of the manipulation member J1 through the manipulation hole 92 in the latch housing 9, and engages (inserts) the first end JIA of the manipulation member J1 with (in) the manipulated part 45 of the lock lever 40.

Next, the user presses down the second end JIB of the manipulation member J1 until the intermediate portion J1C abuts the ridgeline part 97A1. The manipulation member J1 thereby acts as a lever and rectilinearly moves the lock lever 40 upward, wherein the first end JIA serves as the load point, the second end JIB serves as the effort point, and the region near the first end JIA abuts the inner-peripheral surface on the lower side of the manipulation hole 92 to serve as a first fulcrum, as shown in FIG. 16, for the initial phase of pivotal movement of the manipulation member J1.

After the intermediate portion J1C abuts the ridgeline part 97A1, when the user further presses down the second end JIB of the manipulation member J1, the region near the first end JIA stops abutting the inner-peripheral surface on the lower side of the manipulation hole 92. As a result, the manipulation member J1 continues to act as a lever and rectilinearly moves the lock lever 40 further upward, wherein the intermediate portion J1C serves as a second fulcrum, as shown in FIG. 17, for the final phase of pivotal movement of the manipulation member J1.

As a result of this upward movement, the lock lever 40 is switched (moved) to the locked position, thereby disabling actuation of the actuation mechanism 6. When the door is subsequently closed, the latch mechanism 8 holds the door in a closed state relative to the vehicle body.

In addition, in the present door lock apparatus 1, even if water such as rainwater or car washing water passes through the manipulation hole 92, the opposing surface 42A can block (and redirect) the water inside the actuation housing 7 and return (discharge) the water to the exterior of the latch housing 9 and the actuation housing 7 via the discharge port 7H.

Furthermore, in the present door lock apparatus 1, the lock lever 40 can be actuated using only the manipulation member J1 during the emergency operation. Consequently, the emergency lever and the slide lever according to the above-described known vehicle door lock apparatus are unnecessary.

Therefore, in the door lock apparatus 1 according to the present embodiment, actuation of the actuation mechanism 6 can be disabled by performing the emergency operation while also curtailing the ingress of water into the actuation housing 7 through the entry groove 97; furthermore, the part count can be reduced. As a result, the door lock apparatus 1 can reduce manufacturing costs owing to the reduction in part count.

In addition, in the present door lock apparatus 1, as shown in FIG. 16 and FIG. 17, the manipulation member J1 is configured to act as a lever, wherein the first end JIA engages with (in) the manipulated part 45 to serve as the load point, the second end J1B serves as the effort point, and the intermediate portion J1C first abuts the lower side of the manipulation hole 92 and subsequently abuts the ridgeline part 97A1 to serve as first and second fulcrums. Owing to this configuration, the lock lever 40 can be moved rectilinearly from the unlocked position to the locked position more easily than embodiments in which, hypothetically, the manipulation member J1 must be rectilinearly moved (instead of pivoted) to rectilinearly move the lock lever 40 from the unlocked position to the locked position.

Moreover, in the present door lock apparatus 1, the first inner-peripheral surface 92S of the manipulation hole 92 faces downward and is slanted so that it deviates (is inclined) upward as it extends forward so as to approach the opposing surface 42A of the lock lever 40. The second inner-peripheral surface 45S of the manipulated part 45 faces upward and is slanted so that it deviates (is inclined) downward as it extends rearward so as to approach the opposing surface 42A and the manipulation hole 92. Owing to this configuration, because a sufficient stroke for rectilinearly moving the lock lever 40 when the manipulation member J1 acts as a lever can be easily ensured, the length of the manipulation hole 92 in the up-down direction can also be made smaller. As a result, the door lock apparatus 1 is even more capable of curtailing the problem of water penetrating into the actuation housing 7 through the manipulation hole 92 and affecting (e.g., corroding) the components in the actuation housing 7.

In addition, in the present door lock apparatus 1, the manipulation hole 92 is located upward of virtual line K1, which extends parallel to the advancing-retracting direction of the striker S1 at a location at which the distance from virtual line K1 to the upper restricting-end edge 99L1 is equal to the distance from virtual line K1 to the lower restricting-end edge 99L2 in the rectilinear-motion direction (i.e. up-down direction), as shown in FIG. 12. Owing to this configuration, water falling onto the latch housing 9 and the actuation housing 7 from above falls downward and therefore tends not to reach the side surface 97D of the entry groove 97; and, even if water flows toward the side surface 97D of the entry groove 97, it tends not to reach the manipulation hole 92, which is located upward of the virtual line K1. As a result, the present door lock apparatus 1 is even more capable of curtailing the ingress of water into the actuation housing 7 through the manipulation hole 92.

Furthermore, in the present door lock apparatus 1, the opposing surface 42A of the lock lever 40 opposes the manipulation hole 92, the perimeter-edge portion 93, and the ribs 93A, 93B in the rectilinear range of motion of the lock lever 40 from the unlocked position to the locked position, as shown in FIG. 14A to FIG. 17. Owing to this configuration, when the opposing surface 42A returns, to the exterior of the latch housing 9 and the actuation housing 7, water that passes through the manipulation hole 92, even if a portion of such water travels along the opposing surface 42A and penetrates into the interior of the actuation housing 7, the water can be rapidly and effectively shed from the opposing surface 42A downward by the perimeter-edge portion 93 and the ribs 93A, 93B. As a result, the door lock apparatus 1 is capable of curtailing the problem of water penetrating into the actuation housing 7 through the entry groove 97 and affecting the components in the actuation housing 7.

In addition, in the present door lock apparatus 1, the ribs 93A, 93B, as shown in FIG. 11, extend in the up-down direction at locations respectively flanking the manipulation hole 92 in the advancing-retracting direction of the striker S1, and protrude toward the opposing surface 42A. The two slanted ribs 93A1, 93B1 are respectively connected to the lower ends of the ribs 93A, 93B, which are located downward of the manipulation hole 92. The slanted ribs 93A1, 93B1 are slanted so as to approach the inlet 97E of the entry groove 97 in the advancing-retracting direction of the striker S1 as they extend downward. Furthermore, as shown in FIG. 6, the discharge port 7H of the actuation housing 7 allows (enables) fluid communication between the interior and the exterior of the actuation housing 7 downward of the lower ends of the slanted ribs 93A1, 93B1. Owing to this configuration, as shown by the flow of water indicated by broken arrow Y1 in FIG. 5 and the flow of water indicated by broken arrow Y2 in FIG. 6, when the opposing surface 42A returns, to the exterior of the latch housing 9 and the actuation housing 7, water that passes through the manipulation hole 92, even if a portion of such water travels along the opposing surface 42A and penetrates into the interior of the actuation housing 7, the water can be rapidly discharged to the exterior of the actuation housing 7 by the ribs 93A, 93B, the slanted ribs 93A1, 93B1, and the discharge port 7H while being kept away from the components within the actuation housing 7.

Although the present teachings have been described above in accordance with an exemplary embodiment, the present teachings are not limited to the above-described embodiment, and it goes without saying that the present teachings may be modified for application, as appropriate, within a range that does not depart from the gist thereof.

Although the rectilinear-motion direction in which the lock lever 40 rectilinearly moves is the up-down direction, which is at least substantially orthogonal to the advancing-retracting direction, in the embodiment, the present teachings are not limited to this configuration. For example, configurations in which the advancing-retracting direction is the front-rear direction and the rectilinear-motion direction is the vehicle interior-exterior direction or the up-down direction are also encompassed by the present teachings.

The present teachings are applicable to vehicles such as, for example, automobiles, industrial vehicles, and the like.

Representative, non-limiting examples of the present invention were described above in detail with reference to the attached drawings. This detailed description is merely intended to teach a person of skill in the art further details for practicing preferred aspects of the present teachings and is not intended to limit the scope of the invention. Furthermore, each of the additional features and teachings disclosed above may be utilized separately or in conjunction with other features and teachings to provide improved vehicle door lock apparatuses and methods for manufacturing and operating the same.

Moreover, combinations of features and steps disclosed in the above detailed description may not be necessary to practice the invention in the broadest sense, and are instead taught merely to particularly describe representative examples of the invention. Furthermore, various features of the above-described representative examples, as well as the various independent and dependent claims below, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter.

### EXPLANATION OF THE REFERENCE NUMBERS

1 Vehicle door lock apparatus
7, 9 Housing(s) (7: actuation housing; 9: latch housing)
S1 Striker
97 Entry groove
8 Latch mechanism
6 Actuation mechanism
40 Lock lever
97D Side surface of entry groove
91 First wall
J1 Manipulation member
92 Manipulation hole
42A Opposing surface
42 Second wall
45 Manipulated part
J1A First end of manipulation member
97A Bottom surface
97A1 Ridgeline part
J1B Second end of manipulation member
J1C Intermediate portion of manipulation member
92S First inner-peripheral surface
45S Second inner-peripheral surface
99L1 Upper restricting-end edge
99L2 Lower restricting-end edge
K1 Virtual line extending parallel to the advancing-retracting direction at a location at which the distance to the upper restricting-end edge and the distance to the lower restricting-end edge in the rectilinear-motion direction are equal
93 Perimeter-edge portion
93A, 93B Ribs
93A1, 93B1 Slanted ribs
97E Inlet of entry groove
7H Discharge port

1. A vehicle door lock apparatus comprising:
a housing, which is configured to be fixed to a door that is openable and closeable relative to a vehicle body and in which an entry groove, into which a striker fixed to the vehicle body is advanceable, is provided in a recessed manner;
a latch mechanism, which is provided inside the housing and is configured to hold the door in a closed state relative to the vehicle body by engaging with the striker after the striker has advanced into the entry groove;
an actuation mechanism, which is provided inside the housing and is configured to actuate the latch mechanism; and
a lock lever, which is provided inside the housing and is rectilinearly movable in a rectilinear range of motion from an unlocked position, at which actuation of the actuation mechanism is enabled, to a locked position, at which actuation of the actuation mechanism is disabled, and vice versa;
wherein:
the housing has a manipulation hole, which passes through a first wall forming a side surface of the entry groove and through which a manipulation member, which is separate from the vehicle door lock apparatus, is insertable; and
the lock lever comprises:
a second wall having an opposing surface that opposes the manipulation hole in the rectilinear range of motion; and
a manipulated part, which is provided in a recessed manner in the opposing surface and has a blind hole shape, the manipulated part being exposed to the exterior of the housing through the manipulation hole and being engageable with a first end of the manipulation member via the manipulation hole in the rectilinear range of motion.

2. The vehicle door lock apparatus according to claim 1, wherein:
the lock lever is rectilinearly moveable in the rectilinear range of motion in a rectilinear-motion direction that is at least substantially orthogonal to an advancing-retracting direction in which the striker advances and retracts relative to the entry groove;
a first direction of the rectilinear range of motion of the lock lever is the direction in which the lock lever rectilinearly moves from the locked position to the unlocked position;
the entry groove has a bottom surface located, relative to the side surface, in the first direction of the rectilinear-motion direction;
the housing has a ridgeline part, on an end-edge side of the bottom surface that is spaced apart from the side surface, the ridgeline part extending in the advancing-retracting direction; and
the manipulation member is configured to function as a lever, wherein the first end of the manipulation member is configured to engage with the manipulated part of the lock lever in the unlocked position to serve as a load point, a second end of the manipulation member is configured to serve as an effort point, and an intermediate portion of the manipulation member is configured to abut the ridgeline part to serve as a fulcrum for at least a portion of the rectilinear movement of the lock lever from the unlocked position to the locked position.

3. The vehicle door lock apparatus according to claim 2, wherein:
the manipulation hole has a first inner-peripheral surface that is located on the side of a second direction of the rectilinear range of motion that is opposite of the first direction;
the manipulated part has a second inner-peripheral surface that is located on the side of the first direction;
the first inner-peripheral surface faces the first direction and is slanted so as to be inclined in the second direction as the first inner-peripheral surface approaches the opposing surface; and
the second inner-peripheral surface faces the second direction and is so slanted so as to be inclined in the first direction as the second inner-peripheral surface approaches the opposing surface.

4. The vehicle door lock apparatus according to claim 3, wherein:
the advancing-retracting direction is at least substantially horizontal;
the rectilinear-motion direction is an up-down direction that is at least substantially orthogonal to the advancing-retracting direction;
the entry groove has:
an upper restricting-end edge that extends parallel to the advancing-retracting direction and determines an upper-limit position of the striker after the striker has advanced into the deep interior of the entry groove; and
a lower restricting-end edge that extends parallel to the advancing-retracting direction and determines a lower-limit position of the striker after the striker has advanced into the deep interior of the entry groove; and
viewed in the direction in which the manipulation hole passes through the first wall, the manipulation hole is located upward of a virtual line extending parallel to the advancing-retracting direction at a location at which a first distance from the virtual line to the upper restricting-end edge is equal to a second distance from the virtual line to the lower restricting-end edge in the rectilinear-motion direction.

5. The vehicle door lock apparatus according to claim 3, wherein:
the housing has a perimeter-edge portion that is formed on the side of the first wall opposite the side surface, the perimeter-edge portion surrounding the manipulation hole; and
the opposing surface of the lock lever also opposes the perimeter-edge portion in the rectilinear range of motion.

6. The vehicle door lock apparatus according to claim 5, wherein:
the advancing-retracting direction is at least substantially horizontal;
the rectilinear-motion direction is an up-down direction that is at least substantially orthogonal to the advancing-retracting direction;
the perimeter-edge portion has two vertically-extending ribs that extend in the up-down direction at locations respectively flanking the manipulation hole in the advancing-retracting direction and protrude toward the opposing surface of the lock lever;
two slanted ribs are respectively connected to lower ends of the two vertically-extending ribs at locations downward of the manipulation hole and are slanted so as to approach an inlet of the entry groove in the advancing-retracting direction as the two slanted ribs extend downward; and
the housing has a discharge port that allows fluid communication between the interior and the exterior of the housing downward of the lower ends of the two slanted ribs.

7. The vehicle door lock apparatus according to claim 1, wherein:
an advancing-retracting direction, in which the striker advances and retracts relative to the entry groove, is at least substantially horizontal;
the lock lever is rectilinearly moveable in the rectilinear range of motion in a rectilinear-motion direction that extends in an up-down direction that is at least substantially orthogonal to the advancing-retracting direction;
the entry groove has:
an upper restricting-end edge that extends parallel to the advancing-retracting direction and determines an upper-limit position of the striker after the striker has advanced into the deep interior of the entry groove; and
a lower restricting-end edge that extends parallel to the advancing-retracting direction and determines a lower-limit position of the striker after the striker has advanced into the deep interior of the entry groove; and
viewed in the direction in which the manipulation hole passes through the first wall, the manipulation hole is located upward of a virtual line extending parallel to the advancing-retracting direction at a location at which a first distance from the virtual line to the upper restricting-end edge is equal to a second distance from the virtual line to the lower restricting-end edge in the rectilinear-motion direction.

8. The vehicle door lock apparatus according to claim 1, wherein:
the housing has a perimeter-edge portion that is formed on the side of the first wall opposite the side surface, the perimeter-edge portion surrounding the manipulation hole; and
the opposing surface of the lock lever also opposes the perimeter-edge portion in the rectilinear range of motion.

9. The vehicle door lock apparatus according to claim 8, wherein:
an advancing-retracting direction, in which the striker advances and retracts relative to the entry groove, is at least substantially horizontal;
the lock lever is rectilinearly moveable in the rectilinear range of motion in a rectilinear-motion direction that extends in an up-down direction that is at least substantially orthogonal to the advancing-retracting direction;
the perimeter-edge portion has two vertically-extending ribs that extend in the up-down direction at locations respectively flanking the manipulation hole in the advancing-retracting direction and protrude toward the opposing surface of the lock lever;
two slanted ribs are respectively connected to lower ends of the two vertically-extending ribs at locations downward of the manipulation hole and are slanted so as to approach an inlet of the entry groove in the advancing-retracting direction as the two slanted ribs extend downward; and
the housing has a discharge port that allows fluid communication between the interior and the exterior of the housing downward of the lower ends of the two slanted ribs.

10. A vehicle door lock comprising:
a housing configured to be fixed to a vehicle door that is openable and closeable relative to a vehicle body, a striker receiving slot being defined in the housing;
a latch mechanism disposed within the housing and configured to hold the vehicle door in a closed state relative to the vehicle body by engaging the striker after the striker has advanced into the striker receiving slot;
an actuation mechanism disposed within the housing and configured to actuate the latch mechanism; and
a lock lever disposed within the housing, the lock lever being movable in a rectilinear range of motion from an unlocked position, at which actuation of the actuation mechanism is enabled, to a locked position, at which actuation of the actuation mechanism is disabled, and vice versa;
wherein:
an access hole passes through a wall defining a portion of the striker receiving slot, the access hole being configured such that a manipulation tool, which is separate from the vehicle door lock apparatus, is insertable therethrough; and
the lock lever comprises:
an opposing surface that faces the access hole; and
a blind hole defined in the opposing surface and being exposed to the exterior of the housing through the access hole, a first end of the manipulation tool being engageable in the blind hole via the access hole to manually move the lock lever from the unlocked position to the locked position.

11. The vehicle door lock apparatus according to claim 10, wherein:
the rectilinear range of motion of the lock lever extends in a direction that is at least substantially orthogonal to an advancing-retracting direction in which the striker advances and retracts relative to the striker receiving slot;
a rounded corner extends in the advancing-retracting direction along an end of the striker receiving slot that is spaced apart from the access hole in a front-rear direction that is orthogonal to the direction of the rectilinear range of motion and to the advancing-retracting direction; and
the rounded corner is configured to act as a fulcrum for the manipulation tool during at least a portion of pivoting movement of the manipulation tool that manually moves the lock lever from the unlocked position to the locked position.

12. The vehicle door lock apparatus according to claim 11, wherein the direction of the rectilinear range of motion of the lock lever is an up-down direction in a state in which the vehicle door lock apparatus is mounted on a vehicle door.

13. The vehicle door lock apparatus according to claim 12, wherein an uppermost surface of the access hole faces downward in the up-down direction and is inclined such that a first edge of the uppermost surface that is closest to the opposing surface of the lock lever is above a second edge of the uppermost surface that is farthest from the opposing surface of the lock lever in the front-rear direction.

14. The vehicle door lock apparatus according to claim 13, wherein a lowermost surface of the blind hole faces upward in the up-down direction and is inclined such that a first edge of the lowermost surface that is closest to the access hole is below a second edge of the lowermost surface that is farthest from the access hole in the front-rear direction.

15. The vehicle door lock apparatus according to claim 14, wherein:
the advancing-retracting direction is at least substantially horizontal in the state in which the vehicle door lock apparatus is mounted on the vehicle door;
the access hole has:
an upper restricting-end edge that extends parallel to the advancing-retracting direction and determines an upper-limit position of the striker after the striker has advanced into the deep interior of the striker receiving slot; and
a lower restricting-end edge that extends parallel to the advancing-retracting direction and determines a lower-limit position of the striker after the striker has advanced into the deep interior of the striker receiving slot; and
the access hole is disposed upward of a virtual line bisecting the striker receiving slot in the up-down direction.

16. The vehicle door lock apparatus according to claim 15, wherein:
the housing has a perimeter-edge portion that surrounds the access hole; and
the opposing surface of the lock lever opposes the perimeter-edge portion.

17. The vehicle door lock apparatus according to claim 16, wherein:
the perimeter-edge portion has two vertically-extending ribs that extend in the up-down direction at locations respectively flanking the access hole in the advancing-retracting direction and protrude toward the opposing surface of the lock lever;
two slanted ribs are respectively connected to lower ends of the two vertically-extending ribs at locations downward of the access hole and are slanted so as to approach an inlet of the striker receiving slot in the advancing-retracting direction as the two slanted ribs extend downward; and
the housing has a discharge port that allows fluid communication between the interior and the exterior of the housing downward of the lower ends of the two slanted ribs.
